(19) United States
(12) Patent Application Publication
(10) Pub. No.: US 2023/0162278 A1
(43) Pub. Date: May 25, 2023

(54) GENERATION AND DELIVERY OF FUNDING OPPORTUNITIES USING ARTIFICIAL INTELLIGENCE (AI) BASED TECHNIQUES

(71) Applicant: Meta Platforms, Inc., Menlo Park, CA (US)

(72) Inventor: Vincent Andrew MARTIN, Bothell, WA (US)

(73) Assignee: Meta Platforms, Inc., Menlo Park, CA (US)

(21) Appl. No.: 17/972,223

(22) Filed: Oct. 24, 2022

Related U.S. Application Data
(60) Provisional application No. 63/282,562, filed on Nov. 23, 2021.

(51) Int. Cl. G06Q 40/02; G06Q 30/02

(52) U.S. Cl. CPC G06Q 40/025; G06Q 30/0201

(57) ABSTRACT

According to examples, a system for using artificial intelligence (AI) techniques to generate and deliver funding opportunities for entities based on associated data is described. The system may include a processor and a memory storing instructions. The processor, when executing the instructions, may cause the system to access input information related to a funding opportunity associated with an entity; analyze the input information to generate parameters associated with a funding opportunity model; and implement the funding opportunity model. The processor, when executing the instructions, may then modify an aspect of the funding opportunity model; simulate a funding opportunity with respect to the entity using the funding opportunity model; determine one or more aspects of the funding opportunity; verify the one or more aspects of the funding opportunity; and provide one or more funding options to the entity based on the verified one or more aspects of the funding opportunity.

### PRIORITY

This patent application claims priority to U.S. Provisional Patent Application No. 63/282,562, entitled “Generation and Delivery of Funding Opportunities Using Artificial Intelligence (AI) based Techniques,” filed on Nov. 23, 2021.

### TECHNICAL FIELD

This patent application relates generally to generation and delivery of resources, and more specifically, to systems and methods for using artificial intelligence (AI) techniques to generate and deliver funding opportunities for entities based on associated data.

### BACKGROUND

Advances in content management and media distribution are causing users to engage with content on or from a variety of content platforms. In some instances, digital advertising may be an appealing option due to its immediate and versatile nature. For example, new and/or small businesses may find digital advertising appealing because it may offer an opportunity to direct resources in a highly-targeted manner.

However, digital advertising may also come with its own drawbacks. For example, it may be infeasible for a new and/or small business to incur significant costs that may accompany an outreach plan (e.g., an advertising campaign) utilizing digital advertising.

In addition, in many instances, new and/or small businesses may face additional hurdles, in that they may often receive no or insufficient financing from traditional financial institutions (e.g., banks, hedge funds, etc.). And as a result, they may be unable to generate awareness that their businesses may need to thrive.

### BRIEF DESCRIPTION OF DRAWINGS

Features of the present disclosure are illustrated by way of example and not limited in the following figures, in which like numerals indicate like elements. One skilled in the art will readily recognize from the following that alternative examples of the structures and methods illustrated in the figures can be employed without departing from the principles described herein.

FIG. 1 illustrates a diagram of an implementation structure for a neural network (NN) implementing deep learning, according to an example.

FIG. 2A illustrates a block diagram of a system environment, including a system, that may be implemented to use artificial intelligence (AI) techniques to generate funding opportunities for entities based on associated data, according to an example.

FIG. 2B illustrates a block diagram of a system, that may be implemented to use artificial intelligence (AI) techniques to generate funding opportunities for entities based on associated data, according to an example.

FIG. 2C illustrates a flow diagram illustrating aspects of input information using artificial intelligence (AI) techniques to generate funding opportunities for entities based on associated data, according to an example.

FIG. 2D illustrates a flow diagram illustrating aspects of using artificial intelligence (AI) techniques to generate funding opportunities for entities based on associated data, according to an example.

FIG. 2E illustrates a flow diagram illustrating aspects of using artificial intelligence (AI) techniques to generate funding opportunities for entities based on associated data, according to an example.

FIG. 3 illustrates a block diagram of a computer system that may be implemented to use artificial intelligence (AI) techniques to generate funding opportunities for entities based on associated data, according to an example.

FIG. 4 illustrates a flow diagram of a method for using artificial intelligence (AI) techniques to generate funding opportunities for entities based on associated data, according to an example.

### DETAILED DESCRIPTION

For simplicity and illustrative purposes, the present application is described by referring mainly to examples thereof. In the following description, numerous specific details are set forth in order to provide a thorough understanding of the present application. It will be readily apparent, however, that the present application may be practiced without limitation to these specific details. In other instances, some methods and structures readily understood by one of ordinary skill in the art have not been described in detail so as not to unnecessarily obscure the present application. As used herein, the terms “a” and “an” are intended to denote at least one of a particular element, the term “includes” means includes but not limited to, the term “including” means including but not limited to, and the term “based on” means based at least in part on.

Advances in content management and media distribution are causing users to engage with content on or from a variety of content platforms. As used herein, a “user” may include any user of a computing device or digital content delivery mechanism who receives or interacts with delivered content items, which may be visual, non-visual, or a combination thereof. Also, as used herein, “content,” “digital content,” “digital content item” and “content item” may refer to any digital data (e.g., a data file). Examples include, but are not limited to, digital images, digital video files, digital audio files, and/or streaming content. Additionally, the terms “content,” “digital content item,” “content item,” and “digital item” may refer interchangeably to themselves or to portions thereof.

With the proliferation of different types of digital content delivery mechanisms (e.g., mobile phone, portable computing devices, tablet devices, etc.), it has become crucial that content providers, such as vendors looking to advertise a good or service, engage users with content of interest. As a result, content providers are continuously looking for ways to deliver more appealing content.

In some instances, digital advertising may be an appealing option due to its immediate and versatile nature. For example, new and/or small businesses may find digital advertising appealing because it may offer an opportunity to direct resources in a highly-targeted manner to potential customers. So, in one example, a vendor may generate an advertising content item to engage potential customers and distribute the advertising content item over a content platform (e.g., a social media platform) operated by a service provider to make users of the content platform aware of their product.

However, digital advertising may also come with its own drawbacks. For example, it may be infeasible for a new and/or small business to incur costs related to an outreach plan (e.g., an advertising campaign). That is, the new and/or small business may have access to avenues that may enable reaching of potential customers (i.e., content generation, online advertising, etc.), but may not have the means (i.e., funding) required to execute on the outreach plan.

Moreover, in many instances, new and/or small businesses may often receive either insufficient or no financing from traditional financial institutions (e.g., banks, hedge funds, etc.). In some instances, this may be because the financial institutions may have limited data related to operations of the new and/or small business (e.g., revenue, inventory, etc.), and therefore may have difficulty justifying financing for these new and/or small businesses.

Moreover, in many instances, determining financing options may involve determining (i.e., modeling) if a business may be able and willing to repay. In such instances, determining financing options may require evaluation of data (i.e., indicative of a risk of failure to repay) that may change over time (i.e., as the term of credit increases). In the instances where a financial institution may not have access to such data, or may be unable to evaluate such data, the financial institution may be unable to provide financing, which may limit a small business's ability to grow their business.

As an alternative, in some instances, it may be beneficial for a service provider with a pre-existing relationship to an entity (e.g., a new and/or small business) to provide funding opportunities. As used herein, an “entity” may refer to, among other things, any individual, plurality of individuals (e.g., a group), an organization, a business, or any other legal entity that may be in a position to receive funding. Also, as used herein, a “funding opportunity” may include any instance where a first party (i.e., entity) may be in a position to extend to a second party (i.e., entity) funding according to an agreement between the first party and the second party. Examples of funding opportunities may include loans, mortgages, investments, grants, etc.

One such example of a service provider may be a service provider operating a content platform that may offer advertising services. In this example, it may be beneficial to the service provider and an associated entity (e.g., a new and/or small business) for the service provider to offer funding opportunities to a new and/or small business that may be advertising on the content platform. So, in some examples involving an entity without means to advertise as they may wish, a service provider may utilize various information associated with the entity (e.g., advertising expenditures (“adspend”), sales, revenues, etc.) to determine that a funding opportunity may be extended to the entity. As a result, in some instances, the entity may utilize the funding from the funding opportunity to grow, and perhaps even utilize future revenue to additional advertising with the service provider.

Indeed, in some instances, by virtue of a pre-existing relationship between a service provider and an entity (e.g., a new and/or small business), the service providers may be in a unique position to both access and evaluate data necessary to offer a funding opportunity. An example of such data may include “pre-attribution” sales data. In some instances, pre-attribution sales data may refer to data that a business may have provided to a service provider, but may not have been processed to determine relevance to a business's activities (e.g., advertising). So, in an instance where a service provider may attribute transactions (e.g., sales) to outreach efforts (e.g., advertising campaigns), the service provider may (uniquely) be able to generate a more complete and/or longer-term view of an entity's capacity to generate revenue, and may also be able to make predictions about a business's future sales performance (e.g., a probability that a business may default, a projected loss amount in an event of a default, etc.).

Systems and methods described may provide for using artificial intelligence (AI) techniques to generate and deliver funding opportunities for entities based on entity-related data. In some examples, to generate and/or deliver funding opportunities for the entities, the systems and methods may (among other things) access input data associated with the entity, analyze the accessed data to (among other things) determine model parameters for a model, and implement the model to determine whether to offer a funding opportunity to an entity.

In addition, in some examples, the systems and methods may also modify (i.e., “train”) aspects of the model, and may utilize the (optimized) model to make a determination with respect to a funding opportunity and an associated entity. Furthermore, upon making the determination, the systems and methods may also determine one or more aspects (e.g., “pricing” aspects) of the funding opportunity associated with the entity, verify the determined one or more aspects with respect to one or more related entities and/or related funding opportunities, and may provide one or more funding options to an entity.

Before proceeding, it may be beneficial to describe a number of terms as used herein. So, as used herein, a “return payment” may include any payment that may be made by an entity in association with a funding opportunity that may be extended to the entity. Furthermore, a “default” may be a failure to make any return payment that may be in association with a funding opportunity extended to an entity. In addition, a “third party” or “associate” may include any entity other than a service provider providing a funding opportunity and an entity that may be a recipient of a funding opportunity.

In some examples and as described herein, the systems and methods describe may utilize and/or implement a neural network (NN). In some examples, a neural network (NN) that may be implemented may include one or more computing devices configured to implement one or more networked machine-learning (ML) algorithms to “learn” by progressively extracting higher-level information from input data. It should be appreciated that, in addition to or instead of a neural network (NN), other computing mechanisms may be utilized as well, such as tree-based models (e.g., boosted trees).

In some examples, the one or more networked machine-learning (ML) algorithms of a neural network (NN) may implement “deep learning”. A neural network (NN) implementing deep learning and artificial intelligence (AI) techniques may, in some examples, utilize one or more “layers” to dynamically transform input data into progressively more abstract and/or composite representations. These abstract and/or composite representations may be analyzed to determine hidden patterns and correlations and determine one or more relationships or association(s) within the input data. In addition, the one or more determined relationships or associations may be utilized to make predictions, such a likelihood that an entity may be able to make a sufficient number of return payments in relation to a particular funding opportunity.

The systems and methods described herein may utilize various neural network (NN) technologies. Examples of neural network (NN) mechanisms that may be employed may include an artificial neural network (ANN), a sparse neural network (SNN), a convolutional neural network (CNN), and a recurrent neural network (RNN). Additional examples of neural network mechanisms that may be employed may also include a long/short term memory (LSTM), a gated repeated unit (GRU), a Hopfield network, a Boltzmann machine, a deep belief network and a generative adversarial network (GAN).

In some examples, the systems and methods described may include a processor and a memory storing instructions, which when executed by the processor, cause the processor to access input information related to a funding opportunity associated with an entity and analyze the input information to generate parameters associated with a funding opportunity model. In addition, in some examples, the instructions, when executed by the processor, further cause the processor to implement the funding opportunity model, simulate the funding opportunity with respect to the entity using the funding opportunity model, and determine one or more aspects of the funding opportunity.

In some examples, the systems and methods described may include a method of generating and delivering funding opportunities for entities based on associated data, comprising accessing input information related to a funding opportunity associated with an entity and analyzing the input information to generate parameters associated with a funding opportunity model. In addition, the method may further include implementing the funding opportunity model, simulating the funding opportunity with respect to the entity using the funding opportunity model, and determining one or more aspects of the funding opportunity.

In some examples, the systems and methods may include a non-transitory computer-readable storage medium having an executable stored thereon, which when executed instructs a processor to access input information related to a funding opportunity associated with an entity and analyze the input information to generate parameters associated with a funding opportunity model. In addition, the executable, when executed further instructs the processor to implement the funding opportunity model, simulate the funding opportunity with respect to the entity using the funding opportunity model, and determine one or more aspects of the funding opportunity.

As discussed above, in some examples, the systems and methods may gather and utilize information (i.e., data) associated with a user or a user device to generate and deliver funding opportunities for entities based on the associated data. In some examples, the information associated with the user may be gathered and utilized according to various policies. For example, in particular embodiments, privacy settings may allow users to review and control, via opt in or opt out selections, as appropriate, how their data may be collected, used, stored, shared, or deleted by the systems and methods or by other entities (e.g., other users or third-party systems), and for a particular purpose. The systems and methods may present users with an interface indicating what data is being collected, used, stored, or shared by the systems and methods described (or other entities), and for what purpose. Furthermore, the systems and methods may present users with an interface indicating how such data may be collected, used, stored, or shared by particular processes of the systems and methods or other processes (e.g., internal research, advertising algorithms, machine-learning algorithms). In some examples, a user may have to provide prior authorization before the systems and methods may collect, use, store, share, or delete data associated with the user for any purpose.

Moreover, in particular embodiments, privacy policies may limit the types of data that may be collected, used, or shared by particular processes of the systems and methods for a particular purpose. In some examples, the systems and methods may present users with an interface indicating the particular purpose for which data is being collected, used, or shared. In some examples, the privacy policies may ensure that only necessary and relevant data may be collected, used, or shared for the particular purpose, and may prevent such data from being collected, used, or shared for unauthorized purposes.

Also, in some examples, the collection, usage, storage, and sharing of any data may be subject to data minimization policies, which may limit how such data that may be collected, used, stored, or shared by the systems and methods, other entities (e.g., other users or third-party systems), or particular processes (e.g., internal research, advertising algorithms, machine-learning algorithms) for a particular purpose. In some examples, the data minimization policies may ensure that only relevant and necessary data may be accessed by such entities or processes for such purposes.

In addition, it should be appreciated that in some examples, the deletion of any data may be subject to data retention policies, which may limit the duration such data that may be user or stored by the systems and methods (or by other entities), or by particular processes (e.g., internal research, advertising algorithms, machine-learning algorithms) for a particular purpose before being automatically deleted, de-identified, or otherwise made inaccessible. In some examples, the data retention policies may ensure that data may be accessed by such entities or processes only for the duration it is relevant and necessary. In particular examples, privacy settings may allow users to review any of their data stored by the systems and methods or other entities (e.g., third-party systems) for any purpose, and delete such data when requested by the user.

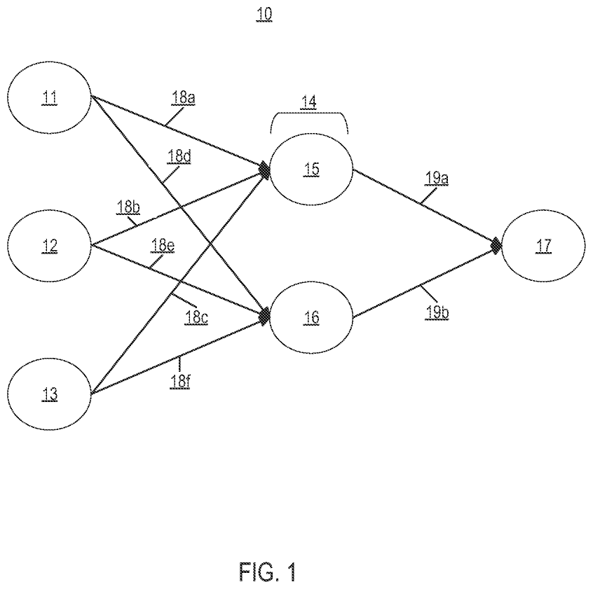

FIG. 1 illustrates a diagram of an implementation structure for a neural network (NN) implementing artificial intelligence (AI) and deep learning, according to an example. In some examples, implementation of neural network 10 (hereinafter also referred to as “network 10”) may include organizing a structure of the network 10 and “training” the network 10. Although an example of a neural network is provided here, it should be appreciated that (as discussed above) other computational methods may be utilized as well.

In some examples, organizing the structure of the network 10 may include network elements including one or more inputs, one or more nodes and an output. In some examples, a structure of the network 10 may be defined to include a plurality of inputs 11, 12, 13, a layer 14 with a plurality of nodes 15, 16, and an output 17.

In addition, in some examples, organizing the structure of the network 10 may include assigning one or more weights associated with the plurality of nodes 15, 16. In some examples, the network 10 may implement a first group of weights 18, including a first weight 18a between the input 11 and the node 15, a second weight 18b between the input 12 and the node 15, a third weight 18c between the input 13 and the node 15. In addition, the network 10 may implement a fourth weight 18d between the input 11 and the node 16, a fifth weight 18e between the input 12 and the node 16, and a sixth weight 18f between the input 13 and the node 16 as well. In addition, a second group of weights 19, including the first weight 19a between the node 15 and the output 17 and the second weight 19b between the node 16 and the output 17 may be implemented as well.

In some examples, “training” the network 10 may include utilization of one or more “training datasets” {(xᵢ, yᵢ)}, where i=1 N for an N number of data pairs. In particular, as will be discussed below, the one or more training datasets {(xᵢ, yᵢ)} may be used to adjust weight values associated with the network 10.

Training of the network 10 may also include, in some examples, may also include implementation of forward propagation and backpropagation. Implementation of forward propagation and backpropagation may include enabling the network 10 to adjust aspects, such as weight values associated with nodes, by looking to past iterations and outputs. In some examples, a forward “sweep” through the network 10 to compute an output for each layer. At this point, in some examples, a difference (i.e., a “loss”) between an output of a final layer and a desired output may be “back-propagated” through previous layers by adjusting weight values associated with the nodes in order to minimize a difference between an estimated output from the network 10 (i.e., an “estimated output”) and an output the network 10 was meant to produce (i.e., a “ground truth”). In some examples, training of the network 10 may require numerous iterations, as the weights may be continually adjusted to minimize a difference between estimated output and an output the network 10 was meant to produce.

In some examples, once weights for the network 10 may be learned, the network 10 may be used make a prediction or “inference”. In some examples, the network 10 may make an inference for a data instance, x*, which may not have been included in the training datasets {(xᵢ, yᵢ)}, to provide an output value y* (i.e., an inference) associated with the data instance x*. Furthermore, in some examples, a prediction loss indicating a predictive quality (i.e., accuracy) of the network 10 may be ascertained by determining a “loss” representing a difference between the estimated output value y* and an associated ground truth value.

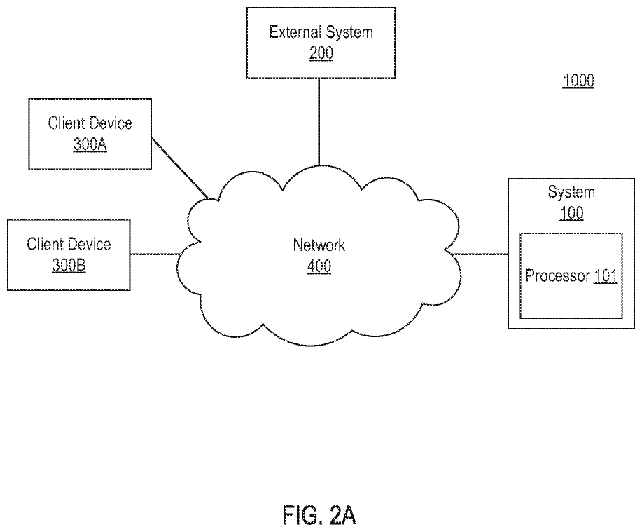

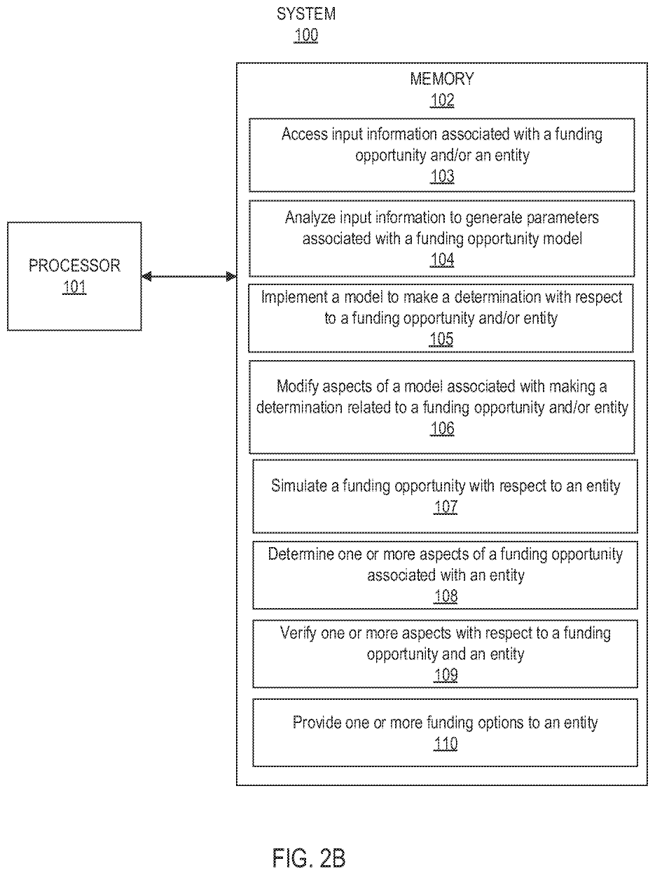

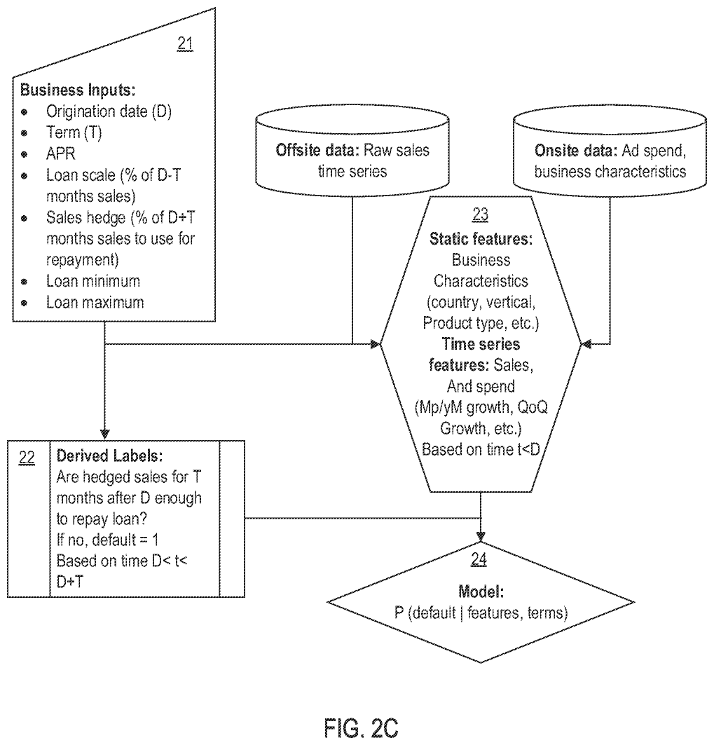

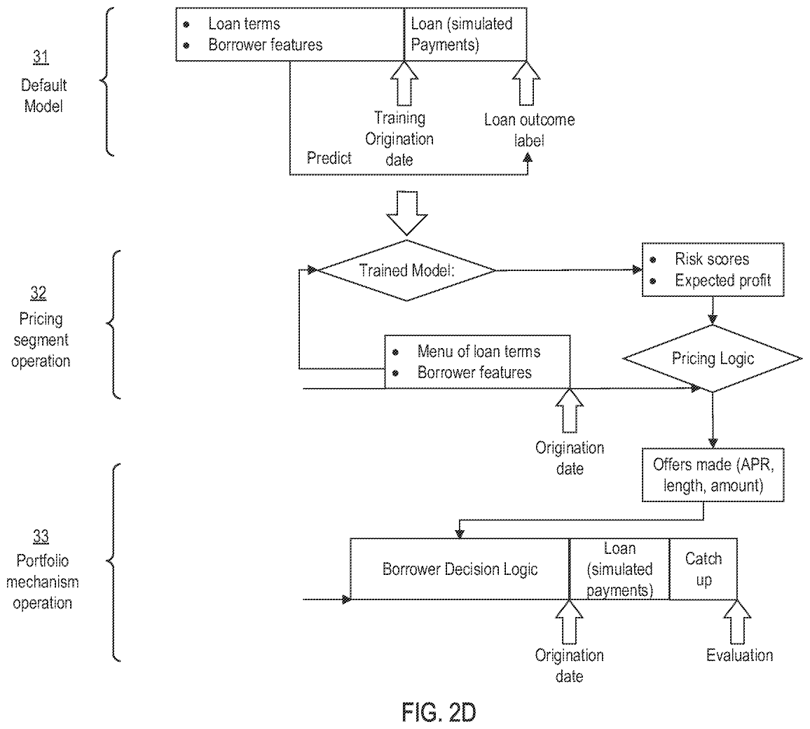

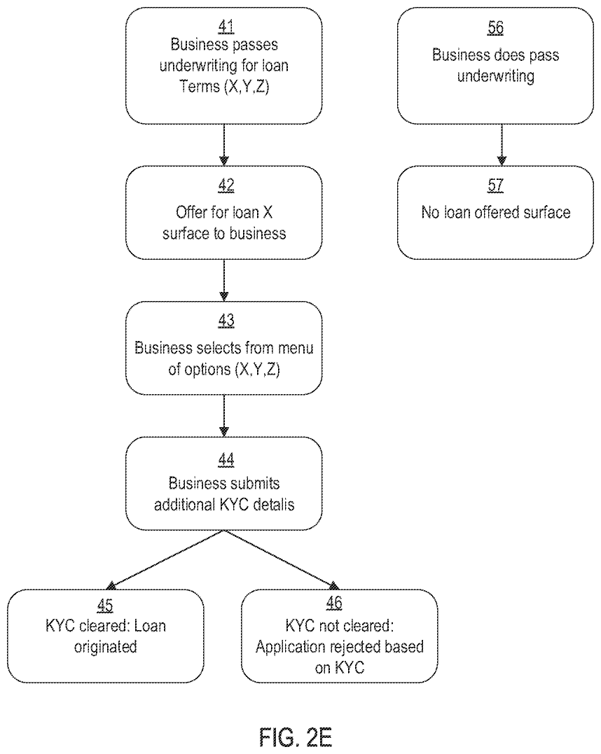

Reference is now made to FIGS. 2A-2B. FIG. 2A illustrates a block diagram of a system environment, including a system, that may be implemented to use artificial intelligence (AI) techniques to generate funding opportunities for entities based on associated data, according to an example. FIG. 2B illustrates a block diagram of a system, that may be implemented to use artificial intelligence (AI) techniques to generate funding opportunities for entities based on associated data, according to an example.

As will be described in the examples below, one or more of system 100, external system 200, user devices 300A-300B and system environment 1000 shown in FIGS. 2A-2B may be operated by a service provider to utilize artificial intelligence (AI) techniques to generate funding opportunities for entities based on associated data. It should be appreciated that one or more of the system 100, the external system 200, the user devices 300A-300B and the system environment 1000 depicted in FIGS. 2A-2B may be provided as examples. Thus, one or more of the system 100, the external system 200 the user devices 300A-300B and the system environment 1000 may or may not include additional features and some of the features described herein may be removed and/or modified without departing from the scopes of the system 100, the external system 200, the user devices 300A-300B and the system environment 1000 outlined herein. Moreover, in some examples, the system 100, the external system 200, and/or the user devices 300A-300B may be or associated with a social networking system, a content sharing network, an advertisement system, an online system, and/or any other system that facilitates any variety of digital content in personal, social, commercial, financial, and/or enterprise environments.

While the servers, systems, subsystems, and/or other computing devices shown in FIGS. 2A-2B may be shown as single components or elements, it should be appreciated that one of ordinary skill in the art would recognize that these single components or elements may represent multiple components or elements, and that these components or elements may be connected via one or more networks. Also, middleware (not shown) may be included with any of the elements or components described herein. The middleware may include software hosted by one or more servers. Furthermore, it should be appreciated that some of the middleware or servers may or may not be needed to achieve functionality. Other types of servers, middleware, systems, platforms, and applications not shown may also be provided at the front-end or back-end to facilitate the features and functionalities of the system 100, the external system 200, the user devices 300A-300B or the system environment 1000.

It should also be appreciated that the systems and methods described herein may be particularly suited for digital content, but are also applicable to a host of other distributed content or media. These may include, for example, content or media associated with data management platforms, search or recommendation engines, social media, and/or data communications involving communication of various information (e.g., transaction information). These and other benefits will be apparent in the descriptions provided herein.

In some examples, the external system 200 may include any number of servers, hosts, systems, and/or databases that store data to be accessed by the system 100, the user devices 300A-300B, and/or other network elements (not shown) in the system environment 1000. In addition, in some examples, the servers, hosts, systems, and/or databases of the external system 200 may include one or more storage mediums storing any data. In some examples, and as will be discussed further below, the external system 200 may be utilized to store any information that may relate to (among other things) activity (i.e., user activity) associated with services offered by a service provider that may be operating the external system 200. As will be discussed further below, in other examples, the external system 200 may be utilized by a service provider (e.g., a social media application provider) as part of a data storage, wherein a service provider may access data on the external system 200 to generate funding opportunities for entities based on associated data.

In some examples, and as will be described in further detail below, the user devices 300A-300B may be utilized to, among other things, utilize artificial intelligence (AI) techniques to generate funding opportunities for entities based on associated data. In some examples, the user devices 300A-300B may be electronic or computing devices configured to transmit and/or receive data.

In this regard, each of the user devices 300A-300B may be any device having computer functionality, such as a television, a radio, a smartphone, a tablet, a laptop, a watch, a desktop, a server, or other computing or entertainment device or appliance. In some examples, the user devices 300A-300B may be mobile devices that are communicatively coupled to the network 400 and enabled to interact with various network elements over the network 400. In some examples, the user devices 300A-300B may execute an application allowing a user of the user devices 300A-300B to interact with various network elements on the network 400. Additionally, the user devices 300A-300B may execute a browser or application to enable interaction between the user devices 300A-300B and the system 100 via the network 400.

Moreover, in some examples and as will also be discussed further below, the user devices 300A-300B may be utilized by a user viewing content (e.g., advertisements) distributed by a service provider, wherein information may be stored and transmitted by the user devices 300A to other devices, such as the external system 200. In some examples, and as will described further below, a user may utilize the user device 300A or the user device 300B to view an advertisement that may be published by a new and/or small business on a content platform operated by a service provider.

The system environment 1000 may also include the network 400. In operation, one or more of the system 100, the external system 200 and the user devices 300A-300B may communicate with one or more of the other devices via the network 400. The network 400 may be a local area network (LAN), a wide area network (WAN), the Internet, a cellular network, a cable network, a satellite network, or other network that facilitates communication between, the system 100, the external system 200, the user devices 300A-300B and/or any other system, component, or device connected to the network 400.

The network 400 may further include one, or any number, of the exemplary types of networks mentioned above operating as a stand-alone network or in cooperation with each other. For example, the network 400 may utilize one or more protocols of one or more clients or servers to which they are communicatively coupled. The network 400 may facilitate transmission of data according to a transmission protocol of any of the devices and/or systems in the network 400. Although the network 400 is depicted as a single network in the system environment 1000 of FIG. 2A, it should be appreciated that, in some examples, the network 400 may include a plurality of interconnected networks as well.

In some examples, and as will be discussed further below, the system 100 may be configured to utilize artificial intelligence (AI) techniques to generate funding opportunities for entities based on associated data. Details of the system 100 and its operation within the system environment 1000 will be described in more detail below.

As shown in FIGS. 2A-2B, the system 100 may include processor 101 and the memory 102. In some examples, the processor 101 may be configured to execute the machine-readable instructions stored in the memory 102. It should be appreciated that the processor 101 may be a semiconductor-based microprocessor, a central processing unit (CPU), an application specific integrated circuit (ASIC), a field-programmable gate array (FPGA), and/or other suitable hardware device.

In some examples, the memory 102 may have stored thereon machine-readable instructions (which may also be termed computer-readable instructions) that the processor 101 may execute. The memory 102 may be an electronic, magnetic, optical, or other physical storage device that contains or stores executable instructions. The memory 102 may be, for example, random access memory (RAM), an Electrically Erasable Programmable Read-Only Memory (EEPROM), a storage device, an optical disc, or the like. The memory 102, which may also be referred to as a computer-readable storage medium, may be a non-transitory machine-readable storage medium, where the term “non-transitory” does not encompass transitory propagating signals. It should be appreciated that the memory 102 depicted in FIGS. 2A-2B may be provided as an example. Thus, the memory 102 may or may not include additional features, and some of the features described herein may be removed and/or modified without departing from the scope of the memory 102 outlined herein.

It should be appreciated that, and as described further below, the processing performed via the instructions on the memory 102 may or may not be performed, in part or in total, with the aid of other information and data, such as information and data provided by the external system 200 and/or the user devices 300A-300B. Moreover, and as described further below, it should be appreciated that the processing performed via the instructions on the memory 102 may or may not be performed, in part or in total, with the aid of or in addition to processing provided by other devices, including for example, the external system 200 and/or the user devices 300A-300B.

In some examples, the memory 102 may store instructions, which when executed by the processor 101, may cause the processor to: access input information associated with a funding opportunity and/or an entity; analyze input information to generate parameters associated with a funding opportunity model; implement a model to make a determination with respect to a funding opportunity and/or an entity. In addition, the instructions, which when executed by the processor 101, may cause the processor to: modify aspects of a model associated with making a determination related to a funding opportunity and/or an entity; simulate a funding opportunity with respect to an entity; and determine one or more aspects of a funding opportunity associated with an entity. Also, instructions, which when executed by the processor 101, may cause the processor to: verify one or more aspects with respect to a funding opportunity and an associated entity, and provide one or more funding options to an entity.

In some examples, and as discussed further below, the instructions 103-110 on the memory 102 may be executed alone or in combination by the processor 101 to utilize artificial intelligence (AI) techniques to generate funding opportunities for entities based on associated data. In some examples, the instructions 103-110 may be implemented in association with a content platform configured to provide content for users, while in other examples, the instructions 103-110 may be implemented as part of a stand-alone application.

Additionally, and as described above, although not depicted, it should be appreciated that to generate funding opportunities for entities based on associated data, instructions 103-110 may be configured to utilize various artificial intelligence (AI) and machine learning (ML) based tools. For instance, these artificial intelligence (AI) and machine learning (ML) based tools may be used to generate models that may include a neural network (e.g., a recurrent neural network (RNN)), generative adversarial network (GAN), a tree-based model, a Bayesian network, a support vector, clustering, a kernel method, a spline, a knowledge graph, or an ensemble of one or more of these and other techniques. It should also be appreciated that the system 100 may provide other types of machine learning (ML) approaches as well, such as reinforcement learning, feature learning, anomaly detection, etc.

In some examples, the instructions 103 may access input information (e.g., data) associated with a funding opportunity and/or an entity. In some examples and as described further below, input data accessed by the instructions 103 may be utilized by a funding opportunity model to determine if one or more entities (e.g., a new and/or small business) may be offered a funding opportunity. In particular, and as described further below, in some examples, various input data may be accessed and utilized to determine one or more (i.e., “end-to-end”) aspects for a funding opportunity.

In some examples, the input information (e.g., data) accessed by the instructions 103 may include funding opportunity-related input data. Examples of this funding opportunity-related input information may include an origination date (D), a term (T) of originating a (hypothetical) funding opportunity to an entity, an annual percentage rate (APR), a loan scale (i.e., percentage (%) of D−T months of sales). As used herein, “origination” of a funding opportunity may include a process associated with offering a funding opportunity to an entity. As used herein, “origination date” may include any date where, after a funding opportunity may have been approved, the associated funding may be provided to an entity. Other examples of information that may be accessed include characteristics associated with the entity, prior sales history for all time periods t<T for the entity, advertising performance metrics for all time periods t<T for the entity, and advertising billing metrics for all time periods t<T for the entity.

Further examples may include a sales hedge (i.e., percentage of D+T months of sales for use for repayment), a loan minimum amount and a loan maximum amount. In some examples, these funding opportunity-related input data may be requested by a requesting entity (e.g., a business), while in other examples the funding opportunity-related input data may be provided by a service provider (e.g., a service provider operating the system 100).

In some examples, the input information (e.g., data) accessed by the instructions 103 may include business-related data. Examples of the types of this business-related input information may include related advertisement-related expenditures, advertisement related parameters and specifications (e.g., business category, timing and period information, etc.), and business characteristics (e.g., relevant market segments).

Additional examples of this information may include transactional information, such as sales information. In particular, the instructions 103 may access “time-series” sales information, which may provide (among other things) one or more of timing, circumstance, and other transactional-related information related to actual transactions (e.g., sales) conducted by the entity. For example, in some instances, timing of an advertisement may be associated with timing of a sale of a related product or service. In these instances, a service provider may be able to access and analyze such data prior to any attribution. As such, in some examples, the transactional information accessed via the instructions 103 may also be referred to as “pre-attribution” transactional data.

Indeed, and as discussed further below, in some examples, the transactional information may, in some instances, indicate efficacy of advertising content of an entity. So, in one example, where a business entity may advertise a product or service using a content item (e.g., a video) on a content platform (e.g., a social media platform), the transactional information related to the advertising efforts (i.e., the advertising campaign) may include conversion (e.g., sales) information related to the advertising. For example, the transactional information may indicate each sale that may have resulted from the advertising. In particular, in some examples, each sale that may result from advertising may be a subset of “pre-attribution” sales (i.e., which may theoretically include all sales associated with the entity).

Accordingly, this transactional information, in turn, may be utilized to generate a description (i.e., a “picture” or “impression”) of the business's entity's transactional capacity (e.g., sales capacity). Furthermore, as described further below, this description may be utilized to generate a probability of risk (i.e., credit risk) associated with a funding opportunity related to the entity (e.g., a particular business).

In addition, as will also be described further below, analysis of this transactional information may provide (i.e., generate) information that may be utilized to model a probability of risk (e.g., a credit risk) associated with a funding opportunity related to the entity (e.g., a particular business). Examples of the types of information that may be generated from this transactional information may include labels that may be input into the model.

It should be appreciated that, in some examples, the input information accessed by the instructions 103 may be associated with a date or time that may be prior to an origination date of a funding opportunity. That is, in some examples, information associated with a date or time after a (selected) origination date of a funding opportunity may not be analyzed (e.g., via the instructions 104) and may not be associated with determining whether to provide a funding opportunity for an entity (e.g., via the instructions 105).

In some examples, the instructions 104 may analyze input information (e.g., input data accessed via the instructions 103) to generate parameters associated with a funding opportunity model. Indeed, as described further below, the parameters generated by the instructions 104 may be utilized to generate and implement a model that may be utilized to determine (among other things) a probability of risk (e.g., a credit risk) associated with a funding opportunity related to the entity (e.g., a new and/or small business) and/or aspects (e.g., pricing aspects, terms, conditions, etc.) associated with the funding opportunity.

In some examples, an example of a parameter generated by the instructions 104 may be a label. As used herein, a label may include, among other things, a classification, designation or description that may be associated with information (e.g., data) that may be provided to a model. An example of a label that may be generated (i.e., derived) via analysis of the input information by the instructions 104 may be a funding opportunity type offered to an entity. Another example of a label may be associated with a variable related to whether hedged sales for a T number of months after an origination date D may be enough to repay a funding opportunity offered to an entity.

In some examples, another example of a parameter that may be generated by the instructions 104 may be a feature. As used herein, a feature may include, among other things, a variable or attribute that may be associated with input information (e.g., input data accessed by the instructions 103). In some examples, a number of the features generated by the instructions 104 may correspond a number of nodes in an input layer of a neural network model (e.g., as described above). Examples of the types of features that may be generated by the instructions 104 may include entity-related features and time-series features. Examples of entity-related features include a country or location associated with the entity, a business “vertical” that may be associated with the entity, and a product type that may be associated with the entity. In some instances, the entity-related features may also be referred to as “static features”. Examples of time-series features may include transactions (e.g., sales) associated with the entity, expenditures (e.g., advertisement expenditures) associated with the entity and other varying information (e.g., month over prior year month (MpyM) growth, quarter-over-quarter (QoQ) growth, etc.).

FIG. 2C illustrates a flow diagram illustrating aspects of input information using artificial intelligence (AI) techniques to generate funding opportunities for entities based on associated data. In some examples, business inputs 21 (e.g., origination date (D), term (T), etc.) along with other inputs (e.g., raw sales time series data, ad spend, etc.) may be utilized to generate derived labels 22 and static features and time series features 23. Furthermore, in some examples, the derived labels 22 and the static features and time series features 23 may be input into a model 24. In some instances, the model 24 may be utilized to determine a funding opportunity for an entity.

In some examples, the instructions 105 may implement a model to make a determination with respect to a funding opportunity and an entity. So, in some examples, the instructions 105 may implement a model that may associated with determining whether to provide a funding opportunity for an entity. In other examples, the instructions 105 may implement a model that may be associated with determining pricing aspects associated with a funding opportunity for an entity.

In some examples, the instructions 105 may utilize one or more labels and one or more features (e.g., as determined via the instructions 104) to generate and/or implement a model associated with simulating various hypothetical funding opportunities for an entity. In particular, the instructions 105 may implement the model to evaluate various information associated with the entity (e.g., time-series sales information), such as the information accessed via the instructions 103, to determine if a business entity may be able to return a sufficient amount of number of return payments associated with a funding opportunity. So, in one example, the model implemented via the instructions 105 may evaluate various information (e.g., time-series revenue information, etc.) related to a new and/or small business (i.e., an entity) to determine whether the business may be able to pay back a certain funding opportunity amount, aspects of the funding opportunity (e.g., pricing terms), and a projected length of time the business may require to pay back the funding opportunity amount. In this example, the instructions 105 may determine whether or not the business would have enough revenue or sales to make sufficient return payments associated with the funding opportunity.

It should be appreciated that, as discussed above, only input information associated with a date prior to an origination date of a funding opportunity may be utilized by the instructions 105. Moreover, in some examples, an (e.g., only) exception to this may be a determination associated with whether or not an entity may be able to make any and/or all return payments associated with a funding opportunity.

In some examples, the instructions 106 may modify aspects of a model (e.g., the model implemented via the instructions 105) associated with making a determination related to a funding opportunity and an entity. That is, in some examples, the model may be modified (i.e., “trained”) in various to achieve various purposes, such as improving an accuracy of a prediction to determine whether to provide a funding opportunity for an entity or to determine pricing aspects associated with a funding opportunity for an entity.

In some examples, the instructions 106 may adjust a model associated with making a determination related to a funding opportunity and an entity. In particular, the instructions 106 may adjust various aspects of the model, such as variables, labels, and weights of the model (as described above). In some examples, the instructions 106 may adjust the various aspects of the model based on various input information to determine if the outcome may be an expected outcome.

In some examples, the instructions 106 may utilize related information (e.g., business information) associated with one or more related entities (i.e., a “portfolio” or “business portfolio”) and/or one or more related transactions to adjust the aspects of the model. That is, in some instances, a simulation performed related to one or more related entities and/or one or more related transactions to adjust the aspects of the model may be referred to as a “portfolio simulation”.

In some examples, during portfolio simulation, the instructions 106 may generate a determination for a future origination date (i.e., beyond the period of any period associated with the information accessed by the instructions 103), and may determine (based on the simulation) that if and/or how likely is it that a sufficient number of return payments associated with one or more funding opportunities simulated in the portfolio simulation may occur. In particular, the instructions 106 may implement the portfolio simulation to determine if one or more entities (e.g., businesses) associated with the one or more funding opportunities simulated in the portfolio simulation are able to generate enough revenue to be able to make a sufficient number of return payments associated with the one or more funding opportunities. Furthermore, in some examples, the instructions 106 may adjust the model to evaluate efficacy (e.g., pricing), and may also be used to “tune” generation and delivery of funding opportunities as described herein.

In some examples, the portfolio simulation implemented by the instructions 106 may also include a “catch-up period,” which may be a time period to enable an entity to “catch up” past return payments in an event that a default (i.e., a non-payment) has occurred with respect to a funding opportunity.

In some examples, the instructions 106 may adjust the model to optimize a likelihood that a (generated) probability that an entity may be able to make any necessary return payments related to a funding opportunity. It should be appreciated that, as discussed above, only input information associated with a date prior to an origination date of a funding opportunity may be utilized by the instructions 106.

In some examples, upon modifying (e.g., optimizing) aspects of a model associated with making a determination related to a funding opportunity and an entity (e.g., via the instructions 106), the instructions 107 may utilize the model to simulate a funding opportunity with respect to an entity. That is and as discussed further below, in some examples, the instructions 107 may implement the model to determine whether a funding opportunity should be offered to a particular or “select” entity.

In some examples, to determine if whether a funding opportunity should be offered to an entity, the instructions 107 may implement a model associated with making a determination related to a funding opportunity and an entity to determine a probability of default (i.e., non-payment). So, in some examples, the instructions 107 may implement the model to utilize various information (e.g., sales information) associated with the entity, a (simulated) funding opportunity amount, a (simulated) interest rate and a (simulated) term of repayment to make one or more determinations related to a probability that a default may occur. That is, in some examples, the instructions 107 may implement the model to simulate, based on various information associated with the entity (e.g., projected sales and revenue), whether the entity may be able to make any necessary return payments related to a funding opportunity associated with the entity.

Furthermore, based on these one or more determinations, the instructions 107 may determine whether offering a funding opportunity may be feasible at all. It should be appreciated that by utilizing the model to simulate one or more funding opportunity conditions (e.g., loan amounts, interest rates, etc.), the instructions 107 may further determine whether to offer a particular funding opportunity to an entity and aspects of a funding opportunity to be offered (e.g., an interest rate, a funding opportunity amount, etc.).

It should be appreciated that, as discussed above, only input information associated with a date prior to an origination date of a funding opportunity associated with the entity may be utilized by the instructions 107. In particular, in contrast to the input information utilized by instructions 103-106, where an origination date may be selected with respect to a simulation condition associated with a model, the input information utilized by the instructions 107 may be associated with a date prior to an origination date of a funding opportunity associated with the (selected) entity themselves.

In some examples, the instructions 108 may determine one or more aspects of a funding opportunity associated with an entity. In particular, upon determining that a funding opportunity associated with an entity may be feasible, the instructions 108 may determine one or more aspects related to the funding opportunity.

In some examples, in determining one or more aspects related to a funding opportunity, the instructions 108 may utilize one or more generated outputs (e.g., scores) from an associated model (e.g., a model implemented via the instructions 107). So, in some examples, the instructions 108 may determine, related to a funding opportunity for an entity, one or more of an interest rate associated with the funding opportunity, an amount of funding for the funding opportunity and a term of repayment for the funding opportunity.

In some examples, the instructions 108 may determine one or more aspects related to a funding opportunity based on an expected return (i.e., expectation). So, in one example, if a funding opportunity for an entity is selected to return one percent (1%) per annum, the instructions 108 may utilize one or more generated outputs (e.g., a probability of default) from an associated model (e.g., a model implemented via the instructions 107) to determine one or more of an interest rate associated with the funding opportunity, an amount of funding for the funding opportunity and a term of repayment for the funding opportunity for the entity that may return one percent (1%) per annum.

In some examples, upon determining that a funding opportunity should be offered to an entity (e.g., via the instructions 107) and determining one or more aspects related to the funding opportunity (e.g., via the instructions 108), the instructions 109 may verify the one or more determined aspects with respect to a funding opportunity and an associated entity. In particular, in some examples, the instructions 109 may “test” the one or more aspects of a determined funding opportunity to determine whether the determine aspects may be in line with other related funding opportunities (i.e., other “portfolio” entities and funding opportunities.

In some examples, the instructions 109 may determine (e.g., in an offline determination) whether or not one or more aspects (e.g., pricing) of a funding opportunity may comport with a particular market segment (i.e., in aggregate). That is, in some examples, the determination by the instructions 109 may not be with respect to an individual borrower. So, in some examples, the instructions 109 may determine that if a funding opportunity may be offered according to one or more determined aspects, that losses associated with the funding opportunity may be substantially higher than an acceptable amount or that anticipated profits may not be in line with an expected profit for such a funding opportunity. In such instance, the instructions 109 may determine that a funding opportunity that may have been offered to an entity should not be offered (i.e., based on the market segment considerations). It should be appreciated that the determination performed by the instructions 109 may be done so “out of time,” in that they may be associated with an origination date that may be beyond a date that may have been in generations of labels (e.g., via the instructions 104).

FIG. 2D illustrates a flow diagram illustrating aspects of using artificial intelligence (AI) techniques to generate funding opportunities for entities based on associated data. In particular, in some examples, the default model 31 may include input of an (training) origination date and a (training) funding opportunity outcome label, wherein features and associated loan terms may be used to determine a funding opportunity decision (e.g., similar to the operations performed via the instructions 107). At this point, in some examples, the funding opportunity decision may input into a pricing segment operation 32, wherein a trained model may generate risk score, an expected profit, along with a menu of loan terms and borrowing logic. In addition, a pricing logic associated with a loan opportunity may be utilized to generate one or more offers (i.e., options) with particular terms (e.g., annual percentage rate (APR), length, amount, etc.) (e.g., similar to the operations performed via the instructions 108). At this point, during portfolio mechanism operation 33, aspects of the model and pricing may be evaluated. In some examples, an output from the portfolio mechanism operation 33 may be used to feed back into the default model 31 or the pricing segment 32 to determine if adjustments may be necessary.

In some examples, upon determining that a funding opportunity should be offered to an entity (e.g., via the instructions 107), determining one or more aspects related to the funding opportunity (e.g., via the instructions 108) and verifying the determining one or more aspects (e.g., via the instructions 109), the instructions 110 may provide one or more funding options to an entity. That is, each funding option may be based on a particular funding opportunity that may be distinct from another particular funding opportunity. In some examples, the entity may select from amongst the one or more funding options.

In particular, in some examples, the instructions 110 may determine one or more funding options to be presented to an entity based on one or more determined funding opportunities for selection. In one example, the instructions 110 may present an entity with a plurality (e.g., three) separate funding opportunities that may each satisfy any associated criteria (e.g., repayment criteria). So, in this example, a loan amount, an interest rate, and a term of repayment for each option may be adjusted (i.e., altered) in order to provide an entity with an ability to select an option that may be most desirable.

FIG. 2E illustrates a flow diagram illustrating aspects of using artificial intelligence (AI) techniques to generate funding opportunities for entities based on associated data. In particular, FIG. 2E illustrates aspects of providing one or more funding options related to one or more funding opportunity provided to an entity. So, in this example, an entity (e.g., business) may “pass” underwriting 41 of one or more funding opportunity (X, Y, Z). At this point, an offer for a funding opportunity 42 (e.g., loan X) with one or more options may be provided to the business. An entity may select 43 from among a menu of options based on the funding opportunity (X, Y, Z), and the entity may submit 44 “know your customer details” prior to determining 45 whether the funding opportunity may be originated or not (i.e., not cleared). In the alternative, in some examples, an entity may not pass 46 a funding opportunity criteria, and no loan 47 may be offered at all as well.

In some examples, prior to or upon providing one or more funding options to an entity, the instructions 110 may further conduct an associated due diligence with respect to the entity. That is, in some examples, the instructions 110 may request and/or verify information associated with the entity to determine if fraud may be involved. In some examples, this may include verification of personal information (e.g., personal identification number), implementation of a captcha or the like. In some examples, this associated due diligence may also be referred to as “know your customer” (i.e., “KYC”).

In some examples, associated due diligence facilitated by the instructions 110 may be conducted (in part or in total) by a third party. So, in one example where the third party may be a bank, the instructions 110 may enable the bank to receive and evaluate risk information associated with an entity (e.g., as generated via the instructions 107), and may provide associated due diligence to determine if the entity or any information provided by the entity may be fraudulent (e.g., verification of a provided bank account number). In some examples, the instructions 110 may further receive a selection from the entity based on the one or more funding options.

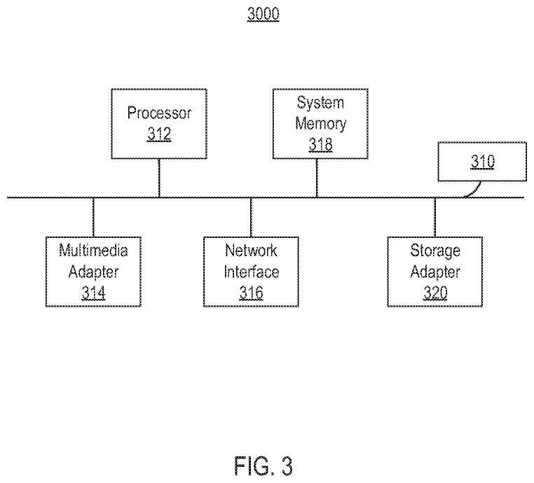

FIG. 3 illustrates a block diagram of a computer system that may be implemented to use artificial intelligence (AI) techniques to generate funding opportunities for entities based on associated data, according to an example. In some examples, the system 3000 may be associated the system 100 to perform the functions and features described herein. The system 3000 may include, among other things, an interconnect 310, a processor 312, a multimedia adapter 314, a network interface 316, a system memory 318, and a storage adapter 320.

The interconnect 310 may interconnect various subsystems, elements, and/or components of the external system 300. As shown, the interconnect 310 may be an abstraction that may represent any one or more separate physical buses, point-to-point connections, or both, connected by appropriate bridges, adapters, or controllers. In some examples, the interconnect 310 may include a system bus, a peripheral component interconnect (PCI) bus or PCI-Express bus, a HyperTransport or industry standard architecture (ISA)) bus, a small computer system interface (SCSI) bus, a universal serial bus (USB), IIC (I2C) bus, or an Institute of Electrical and Electronics Engineers (IEEE) standard 1394 bus, or “firewire,” or other similar interconnection element.

In some examples, the interconnect 310 may allow data communication between the processor 312 and system memory 318, which may include read-only memory (ROM) or flash memory (neither shown), and random access memory (RAM) (not shown). It should be appreciated that the RAM may be the main memory into which an operating system and various application programs may be loaded. The ROM or flash memory may contain, among other code, the Basic Input-Output system (BIOS) which controls basic hardware operation such as the interaction with one or more peripheral components.

The processor 312 may be the central processing unit (CPU) of the computing device and may control overall operation of the computing device. In some examples, the processor 312 may accomplish this by executing software or firmware stored in system memory 318 or other data via the storage adapter 320. The processor 312 may be, or may include, one or more programmable general-purpose or special-purpose microprocessors, digital signal processors (DSPs), programmable controllers, application specific integrated circuits (ASICs), programmable logic device (PLDs), trust platform modules (TPMs), field-programmable gate arrays (FPGAs), other processing circuits, or a combination of these and other devices.

The multimedia adapter 314 may connect to various multimedia elements or peripherals. These may include devices associated with visual (e.g., video card or display), audio (e.g., sound card or speakers), and/or various input/output interfaces (e.g., mouse, keyboard, touchscreen).

The network interface 316 may provide the computing device with an ability to communicate with a variety of remote devices over a network (e.g., network 400 of FIG. 1A) and may include, for example, an Ethernet adapter, a Fibre Channel adapter, and/or other wired- or wireless-enabled adapter. The network interface 316 may provide a direct or indirect connection from one network element to another, and facilitate communication and between various network elements.

The storage adapter 320 may connect to a standard computer-readable medium for storage and/or retrieval of information, such as a fixed disk drive (internal or external).

Many other devices, components, elements, or subsystems (not shown) may be connected in a similar manner to the interconnect 310 or via a network (e.g., network 400 of FIG. 1A). Conversely, all of the devices shown in FIG. 3 need not be present to practice the present disclosure. The devices and subsystems can be interconnected in different ways from that shown in FIG. 3. Code to implement the dynamic approaches for payment gateway selection and payment transaction processing of the present disclosure may be stored in computer-readable storage media such as one or more of system memory 318 or other storage. Code to implement the dynamic approaches for payment gateway selection and payment transaction processing of the present disclosure may also be received via one or more interfaces and stored in memory. The operating system provided on system 100 may be MS-DOS, MS-WINDOWS, OS/2, OS X, IOS, ANDROID, UNIX, Linux, or another operating system.

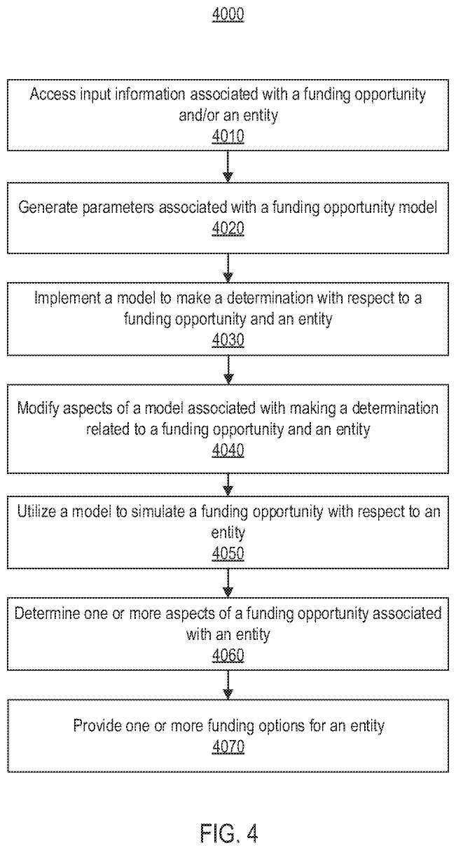

FIG. 4 illustrates a flow diagram of a method for using artificial intelligence (AI) techniques to generate funding opportunities for entities based on associated data, according to an example. The method 4000 is provided by way of example, as there may be a variety of ways to carry out the method described herein. Each block shown in FIG. 4 may further represent one or more processes, methods, or subroutines, and one or more of the blocks may include machine-readable instructions stored on a non-transitory computer-readable medium and executed by a processor or other type of processing circuit to perform one or more operations described herein.

Although the method 4000 is primarily described as being performed by system 100 as shown in FIGS. 2A-2B, the method 4000 may be executed or otherwise performed by other systems, or a combination of systems. It should be appreciated that, in some examples, to generate funding opportunities for entities based on associated data, the method 4000 may be configured to incorporate artificial intelligence (AI) or deep learning techniques, as described above. It should also be appreciated that, in some examples, the method 4000 may be implemented in conjunction with a content platform (e.g., a social media platform) to generate and deliver content.

Reference is now made with respect to FIG. 4. At 4010, the processor 101 may access input information (e.g., data) associated with a funding opportunity and/or an entity. Examples of funding opportunity-related input information may be an origination date (D), a term (T), an annual percentage rate (APR), a loan scale (i.e., percentage (%) of D−T months of sales). Examples of business-related input information may include related advertisement-related expenditures, advertisement related parameters and specifications (e.g., business category, timing and period information, etc.), and business characteristics (e.g., market segments). Additional examples of input information may include transactional information, such as “time-series” sales information.

At 4020, the processor 101 may generate parameters associated with a funding opportunity model. In some examples, an example of a parameter generated by the processor 101 may be a label. In some examples, another example of a parameter that may be generated by the processor 101 may be a feature.

At 4030, the processor 101 may implement a model to make a determination with respect to a funding opportunity and an entity. So, in some examples, the processor 101 may implement a model that may associated with determining whether to provide a funding opportunity for an entity. In other examples, the processor 101 may implement a model that may be associated with determining pricing aspects associated with a funding opportunity for an entity. In some examples, the processor 101 may utilize one or more labels and one or more features to generate and/or implement a model associated with simulating various hypothetical funding opportunities for an entity.

At 4040, the processor 101 may modify aspects of a model associated with making a determination related to a funding opportunity and an entity. That is, in some examples, the model may be modified (i.e., “trained”) in various to achieve various purposes, such as improving an accuracy of a prediction that may be generated to determine whether to provide a funding opportunity for an entity or determine pricing aspects associated with a funding opportunity for an entity. In some examples, the processor 101 may adjust various aspects of the model, such as variables, labels, and weights of the model. In some examples, the processor 101 may adjust the various aspects of the model based on various input information to determine if the outcome may be an expected outcome.

At 4050, the processor 101 may utilize the model to simulate a funding opportunity with respect to an entity. That is and as discussed further below, in some examples, the processor 101 may implement the model to determine whether a funding opportunity should be offered to a particular or “select” entity. In some examples, the processor 101 may implement the model to simulate, based on various information associated with the entity (e.g., projected sales and revenue), whether the entity may be able to make any necessary return payments related to a funding opportunity associated with the entity.

At 4060, the processor 101 may determine one or more aspects of a funding opportunity associated with an entity. In particular, upon determining that a funding opportunity associated with an entity may be feasible, the processor 101 may determine one or more aspects related to the funding opportunity. So, in some examples, the processor 101 may determine, related to a funding opportunity for an entity, one or more of an interest rate associated with the funding opportunity, an amount of funding for the funding opportunity and a term of repayment for the funding opportunity.

At 4070, the processor 101 may provide one or more funding options to an entity. In one example, the processor 101 may present an entity with a plurality (e.g., three) separate funding opportunities that may each satisfy any associated criteria (e.g., repayment criteria). So, in this example, a loan amount, an interest rate, and a term of repayment for each option may be adjusted (i.e., altered) in order to provide an entity with an ability to select an option that may be most desirable.

Although the methods and systems as described herein may be directed mainly to digital content, such as videos or interactive media, it should be appreciated that the methods and systems as described herein may be used for other types of content or scenarios as well. Other applications or uses of the methods and systems as described herein may also include social networking, marketing, content-based recommendation engines, and/or other types of knowledge or data-driven systems.

It should be noted that the functionality described herein may be subject to one or more privacy policies, described below, enforced by the system 100, the external system 200, and the user devices 300A-300B that may bar use of images for concept detection, recommendation, generation, and analysis.

In particular examples, one or more objects of a computing system may be associated with one or more privacy settings. The one or more objects may be stored on or otherwise associated with any suitable computing system or application, such as, for example, the system 100, the external system 200, and the user devices 300, a social-networking application, a messaging application, a photo-sharing application, or any other suitable computing system or application. Although the examples discussed herein may be in the context of an online social network, these privacy settings may be applied to any other suitable computing system. Privacy settings (or “access settings”) for an object may be stored in any suitable manner, such as, for example, in association with the object, in an index on an authorization server, in another suitable manner, or any suitable combination thereof. A privacy setting for an object may specify how the object (or particular information associated with the object) can be accessed, stored, or otherwise used (e.g., viewed, shared, modified, copied, executed, surfaced, or identified) within the online social network. When privacy settings for an object allow a particular user or other entity to access that object, the object may be described as being “visible” with respect to that user or other entity. As an example and not by way of limitation, a user of the online social network may specify privacy settings for a user-profile page that identify a set of users that may access work-experience information on the user-profile page, thus excluding other users from accessing that information.

In particular examples, privacy settings for an object may specify a “blocked list” of users or other entities that should not be allowed to access certain information associated with the object. In particular examples, the blocked list may include third-party entities. The blocked list may specify one or more users or entities for which an object is not visible. As an example and not by way of limitation, a user may specify a set of users who may not access photo albums associated with the user, thus excluding those users from accessing the photo albums (while also possibly allowing certain users not within the specified set of users to access the photo albums). In particular examples, privacy settings may be associated with particular social-graph elements. Privacy settings of a social-graph element, such as a node or an edge, may specify how the social-graph element, information associated with the social-graph element, or objects associated with the social-graph element can be accessed using the online social network. As an example and not by way of limitation, a particular concept node corresponding to a particular photo may have a privacy setting specifying that the photo may be accessed only by users tagged in the photo and friends of the users tagged in the photo. In particular examples, privacy settings may allow users to opt in to or opt out of having their content, information, or actions stored/logged by the system 100, the external system 200, and the user devices 300, or shared with other systems. Although this disclosure describes using particular privacy settings in a particular manner, this disclosure contemplates using any suitable privacy settings in any suitable manner.

In particular examples, the system 100, the external system 200, and the user devices 300A-300B may present a “privacy wizard” (e.g., within a webpage, a module, one or more dialog boxes, or any other suitable interface) to the first user to assist the first user in specifying one or more privacy settings. The privacy wizard may display instructions, suitable privacy-related information, current privacy settings, one or more input fields for accepting one or more inputs from the first user specifying a change or confirmation of privacy settings, or any suitable combination thereof. In particular examples, the system 100, the external system 200, and the user devices 300A-300B may offer a “dashboard” functionality to the first user that may display, to the first user, current privacy settings of the first user. The dashboard functionality may be displayed to the first user at any appropriate time (e.g., following an input from the first user summoning the dashboard functionality, following the occurrence of a particular event or trigger action). The dashboard functionality may allow the first user to modify one or more of the first user's current privacy settings at any time, in any suitable manner (e.g., redirecting the first user to the privacy wizard).

Privacy settings associated with an object may specify any suitable granularity of permitted access or denial of access. As an example and not by way of limitation, access or denial of access may be specified for particular users (e.g., only me, my roommates, my boss), users within a particular degree-of-separation (e.g., friends, friends-of-friends), user groups (e.g., the gaming club, my family), user networks (e.g., employees of particular employers, students or alumni of particular university), all users (“public”), no users (“private”), users of third-party systems, particular applications (e.g., third-party applications, external websites), other suitable entities, or any suitable combination thereof. Although this disclosure describes particular granularities of permitted access or denial of access, this disclosure contemplates any suitable granularities of permitted access or denial of access.

In particular examples, different objects of the same type associated with a user may have different privacy settings. Different types of objects associated with a user may have different types of privacy settings. As an example and not by way of limitation, a first user may specify that the first user's status updates are public, but any images shared by the first user are visible only to the first user's friends on the online social network. As another example and not by way of limitation, a user may specify different privacy settings for different types of entities, such as individual users, friends-of-friends, followers, user groups, or corporate entities. As another example and not by way of limitation, a first user may specify a group of users that may view videos posted by the first user, while keeping the videos from being visible to the first user's employer. In particular examples, different privacy settings may be provided for different user groups or user demographics.

In particular examples, the system 100, the external system 200, and the user devices 300A-300B may provide one or more default privacy settings for each object of a particular object-type. A privacy setting for an object that is set to a default may be changed by a user associated with that object. As an example and not by way of limitation, all images posted by a first user may have a default privacy setting of being visible only to friends of the first user and, for a particular image, the first user may change the privacy setting for the image to be visible to friends and friends-of-friends.

In particular examples, privacy settings may allow a first user to specify (e.g., by opting out, by not opting in) whether the system 100, the external system 200, and the user devices 300A-300B may receive, collect, log, or store particular objects or information associated with the user for any purpose. In particular examples, privacy settings may allow the first user to specify whether particular applications or processes may access, store, or use particular objects or information associated with the user. The privacy settings may allow the first user to opt in or opt out of having objects or information accessed, stored, or used by specific applications or processes. The system 100, the external system 200, and the user devices 300A-300B may access such information in order to provide a particular function or service to the first user, without the system 100, the external system 200, and the user devices 300A-300B having access to that information for any other purposes. Before accessing, storing, or using such objects or information, the system 100, the external system 200, and the user devices 300A-300B may prompt the user to provide privacy settings specifying which applications or processes, if any, may access, store, or use the object or information prior to allowing any such action. As an example and not by way of limitation, a first user may transmit a message to a second user via an application related to the online social network (e.g., a messaging app), and may specify privacy settings that such messages should not be stored by the system 100, the external system 200, and the user devices 300.

In particular examples, a user may specify whether particular types of objects or information associated with the first user may be accessed, stored, or used by the system 100, the external system 200, and the user devices 300. As an example and not by way of limitation, the first user may specify that images sent by the first user through the system 100, the external system 200, and the user devices 300A-300B may not be stored by the system 100, the external system 200, and the user devices 300. As another example and not by way of limitation, a first user may specify that messages sent from the first user to a particular second user may not be stored by the system 100, the external system 200, and the user devices 300. As yet another example and not by way of limitation, a first user may specify that all objects sent via a particular application may be saved by the system 100, the external system 200, and the user devices 300.

In particular examples, privacy settings may allow a first user to specify whether particular objects or information associated with the first user may be accessed from the system 100, the external system 200, and the user devices 300. The privacy settings may allow the first user to opt in or opt out of having objects or information accessed from a particular device (e.g., the phone book on a user's smart phone), from a particular application (e.g., a messaging app), or from a particular system (e.g., an email server). The system 100, the external system 200, and the user devices 300A-300B may provide default privacy settings with respect to each device, system, or application, and/or the first user may be prompted to specify a particular privacy setting for each context. As an example and not by way of limitation, the first user may utilize a location-services feature of the system 100, the external system 200, and the user devices 300A-300B to provide recommendations for restaurants or other places in proximity to the user. The first user's default privacy settings may specify that the system 100, the external system 200, and the user devices 300A-300B may use location information provided from one of the user devices 300A-300B of the first user to provide the location-based services, but that the system 100, the external system 200, and the user devices 300A-300B may not store the location information of the first user or provide it to any external system. The first user may then update the privacy settings to allow location information to be used by a third-party image-sharing application in order to geo-tag photos.

In particular examples, privacy settings may allow a user to specify whether current, past, or projected mood, emotion, or sentiment information associated with the user may be determined, and whether particular applications or processes may access, store, or use such information. The privacy settings may allow users to opt in or opt out of having mood, emotion, or sentiment information accessed, stored, or used by specific applications or processes. The system 100, the external system 200, and the user devices 300A-300B may predict or determine a mood, emotion, or sentiment associated with a user based on, for example, inputs provided by the user and interactions with particular objects, such as pages or content viewed by the user, posts or other content uploaded by the user, and interactions with other content of the online social network. In particular examples, the system 100, the external system 200, and the user devices 300A-300B may use a user's previous activities and calculated moods, emotions, or sentiments to determine a present mood, emotion, or sentiment. A user who wishes to enable this functionality may indicate in their privacy settings that they opt in to the system 100, the external system 200, and the user devices 300A-300B receiving the inputs necessary to determine the mood, emotion, or sentiment. As an example and not by way of limitation, the system 100, the external system 200, and the user devices 300A-300B may determine that a default privacy setting is to not receive any information necessary for determining mood, emotion, or sentiment until there is an express indication from a user that the system 100, the external system 200, and the user devices 300A-300B may do so. By contrast, if a user does not opt in to the system 100, the external system 200, and the user devices 300A-300B receiving these inputs (or affirmatively opts out of the system 100, the external system 200, and the user devices 300A-300B receiving these inputs), the system 100, the external system 200, and the user devices 300A-300B may be prevented from receiving, collecting, logging, or storing these inputs or any information associated with these inputs. In particular examples, the system 100, the external system 200, and the user devices 300A-300B may use the predicted mood, emotion, or sentiment to provide recommendations or advertisements to the user. In particular examples, if a user desires to make use of this function for specific purposes or applications, additional privacy settings may be specified by the user to opt in to using the mood, emotion, or sentiment information for the specific purposes or applications. As an example and not by way of limitation, the system 100, the external system 200, and the user devices 300A-300B may use the user's mood, emotion, or sentiment to provide newsfeed items, pages, friends, or advertisements to a user. The user may specify in their privacy settings that the system 100, the external system 200, and the user devices 300A-300B may determine the user's mood, emotion, or sentiment. The user may then be asked to provide additional privacy settings to indicate the purposes for which the user's mood, emotion, or sentiment may be used. The user may indicate that the system 100, the external system 200, and the user devices 300A-300B may use his or her mood, emotion, or sentiment to provide newsfeed content and recommend pages, but not for recommending friends or advertisements. The system 100, the external system 200, and the user devices 300A-300B may then only provide newsfeed content or pages based on user mood, emotion, or sentiment, and may not use that information for any other purpose, even if not expressly prohibited by the privacy settings.

In particular examples, privacy settings may allow a user to engage in the ephemeral sharing of objects on the online social network. Ephemeral sharing refers to the sharing of objects (e.g., posts, photos) or information for a finite period of time. Access or denial of access to the objects or information may be specified by time or date. As an example and not by way of limitation, a user may specify that a particular image uploaded by the user is visible to the user's friends for the next week, after which time the image may no longer be accessible to other users. As another example and not by way of limitation, a company may post content related to a product release ahead of the official launch, and specify that the content may not be visible to other users until after the product launch.

In particular examples, for particular objects or information having privacy settings specifying that they are ephemeral, the system 100, the external system 200, and the user devices 300A-300B may be restricted in its access, storage, or use of the objects or information. The system 100, the external system 200, and the user devices 300A-300B may temporarily access, store, or use these particular objects or information in order to facilitate particular actions of a user associated with the objects or information, and may subsequently delete the objects or information, as specified by the respective privacy settings. As an example and not by way of limitation, a first user may transmit a message to a second user, and the system 100, the external system 200, and the user devices 300A-300B may temporarily store the message in a content data store until the second user has viewed or downloaded the message, at which point the system 100, the external system 200, and the user devices 300A-300B may delete the message from the data store. As another example and not by way of limitation, continuing with the prior example, the message may be stored for a specified period of time (e.g., 2 weeks), after which point the system 100, the external system 200, and the user devices 300A-300B may delete the message from the content data store.

In particular examples, privacy settings may allow a user to specify one or more geographic locations from which objects can be accessed. Access or denial of access to the objects may depend on the geographic location of a user who is attempting to access the objects. As an example and not by way of limitation, a user may share an object and specify that only users in the same city may access or view the object. As another example and not by way of limitation, a first user may share an object and specify that the object is visible to second users only while the first user is in a particular location. If the first user leaves the particular location, the object may no longer be visible to the second users. As another example and not by way of limitation, a first user may specify that an object is visible only to second users within a threshold distance from the first user. If the first user subsequently changes location, the original second users with access to the object may lose access, while a new group of second users may gain access as they come within the threshold distance of the first user.

In particular examples, the system 100, the external system 200, and the user devices 300A-300B may have functionalities that may use, as inputs, personal or biometric information of a user for user-authentication or experience-personalization purposes. A user may opt to make use of these functionalities to enhance their experience on the online social network. As an example and not by way of limitation, a user may provide personal or biometric information to the system 100, the external system 200, and the user devices 300. The user's privacy settings may specify that such information may be used only for particular processes, such as authentication, and further specify that such information may not be shared with any external system or used for other processes or applications associated with the system 100, the external system 200, and the user devices 300. As another example and not by way of limitation, the system 100, the external system 200, and the user devices 300A-300B may provide a functionality for a user to provide voice-print recordings to the online social network. As an example and not by way of limitation, if a user wishes to utilize this function of the online social network, the user may provide a voice recording of his or her own voice to provide a status update on the online social network. The recording of the voice-input may be compared to a voice print of the user to determine what words were spoken by the user. The user's privacy setting may specify that such voice recording may be used only for voice-input purposes (e.g., to authenticate the user, to send voice messages, to improve voice recognition in order to use voice-operated features of the online social network), and further specify that such voice recording may not be shared with any external system or used by other processes or applications associated with the system 100, the external system 200, and the user devices 300. As another example and not by way of limitation, the system 100, the external system 200, and the user devices 300A-300B may provide a functionality for a user to provide a reference image (e.g., a facial profile, a retinal scan) to the online social network. The online social network may compare the reference image against a later-received image input (e.g., to authenticate the user, to tag the user in photos). The user's privacy setting may specify that such voice recording may be used only for a limited purpose (e.g., authentication, tagging the user in photos), and further specify that such voice recording may not be shared with any external system or used by other processes or applications associated with the system 100, the external system 200, and the user devices 300.

In particular examples, changes to privacy settings may take effect retroactively, affecting the visibility of objects and content shared prior to the change. As an example and not by way of limitation, a first user may share a first image and specify that the first image is to be public to all other users. At a later time, the first user may specify that any images shared by the first user should be made visible only to a first user group. The system 100, the external system 200, and the user devices 300A-300B may determine that this privacy setting also applies to the first image and make the first image visible only to the first user group. In particular examples, the change in privacy settings may take effect only going forward. Continuing the example above, if the first user changes privacy settings and then shares a second image, the second image may be visible only to the first user group, but the first image may remain visible to all users. In particular examples, in response to a user action to change a privacy setting, the system 100, the external system 200, and the user devices 300A-300B may further prompt the user to indicate whether the user wants to apply the changes to the privacy setting retroactively. In particular examples, a user change to privacy settings may be a one-off change specific to one object. In particular examples, a user change to privacy may be a global change for all objects associated with the user.

In particular examples, the system 100, the external system 200, and the user devices 300A-300B may determine that a first user may want to change one or more privacy settings in response to a trigger action associated with the first user. The trigger action may be any suitable action on the online social network. As an example and not by way of limitation, a trigger action may be a change in the relationship between a first and second user of the online social network (e.g., “un-friending” a user, changing the relationship status between the users). In particular examples, upon determining that a trigger action has occurred, the system 100, the external system 200, and the user devices 300A-300B may prompt the first user to change the privacy settings regarding the visibility of objects associated with the first user. The prompt may redirect the first user to a workflow process for editing privacy settings with respect to one or more entities associated with the trigger action. The privacy settings associated with the first user may be changed only in response to an explicit input from the first user, and may not be changed without the approval of the first user. As an example and not by way of limitation, the workflow process may include providing the first user with the current privacy settings with respect to the second user or to a group of users (e.g., un-tagging the first user or second user from particular objects, changing the visibility of particular objects with respect to the second user or group of users), and receiving an indication from the first user to change the privacy settings based on any of the methods described herein, or to keep the existing privacy settings.

In particular examples, a user may need to provide verification of a privacy setting before allowing the user to perform particular actions on the online social network, or to provide verification before changing a particular privacy setting. When performing particular actions or changing a particular privacy setting, a prompt may be presented to the user to remind the user of his or her current privacy settings and to ask the user to verify the privacy settings with respect to the particular action. Furthermore, a user may need to provide confirmation, double-confirmation, authentication, or other suitable types of verification before proceeding with the particular action, and the action may not be complete until such verification is provided. As an example and not by way of limitation, a user's default privacy settings may indicate that a person's relationship status is visible to all users (e.g., “public”). However, if the user changes his or her relationship status, the system 100, the external system 200, and the user devices 300A-300B may determine that such action may be sensitive and may prompt the user to confirm that his or her relationship status should remain public before proceeding. As another example and not by way of limitation, a user's privacy settings may specify that the user's posts are visible only to friends of the user. However, if the user changes the privacy setting for his or her posts to being public, the system 100, the external system 200, and the user devices 300A-300B may prompt the user with a reminder of the user's current privacy settings of posts being visible only to friends, and a warning that this change will make all of the user's past posts visible to the public. The user may then be required to provide a second verification, input authentication credentials, or provide other types of verification before proceeding with the change in privacy settings. In particular examples, a user may need to provide verification of a privacy setting on a periodic basis. A prompt or reminder may be periodically sent to the user based either on time elapsed or a number of user actions. As an example and not by way of limitation, the system 100, the external system 200, and the user devices 300A-300B may send a reminder to the user to confirm his or her privacy settings every six months or after every ten photo posts. In particular examples, privacy settings may also allow users to control access to the objects or information on a per-request basis. As an example and not by way of limitation, the system 100, the external system 200, and the user devices 300A-300B may notify the user whenever an external system attempts to access information associated with the user, and require the user to provide verification that access should be allowed before proceeding.

What has been described and illustrated herein are examples of the disclosure along with some variations. The terms, descriptions, and figures used herein are set forth by way of illustration only and are not meant as limitations. Many variations are possible within the scope of the disclosure, which is intended to be defined by the following claims—and their equivalents—in which all terms are meant in their broadest reasonable sense unless otherwise indicated.

1. A system, comprising:
a processor;
a memory storing instructions, which when executed by the processor, cause the processor to:
access input information related to a funding opportunity associated with an entity;
analyze the input information to generate parameters associated with a funding opportunity model;
implement the funding opportunity model;
simulate the funding opportunity with respect to the entity using the funding opportunity model; and
determine one or more aspects of the funding opportunity.

2. The system of claim 1, wherein the instructions, which when executed by the processor, cause the processor to modify an aspect of the funding opportunity model.

3. The system of claim 1, wherein the instructions, which when executed by the processor, cause the processor to verify the one or more aspects of the funding opportunity.

4. The system of claim 3, wherein the instructions, which when executed by the processor, cause the processor to provide one or more funding options to the entity based on the one or more aspects of the funding opportunity.

5. The system of claim 1, wherein the parameters include one of a label and a feature.

6. The system of claim 1, wherein the one or more aspects of the funding opportunity include an amount of the funding opportunity, an interest rate for the funding opportunity, and a duration of the funding opportunity.

7. The system of claim 1, wherein the instructions, which when executed by the processor, cause the processor to receive a selection from the entity with respect to the one or more funding options.

8. A method of generating and delivering funding opportunities for entities based on associated data, comprising:
accessing input information related to a funding opportunity associated with an entity;
analyzing the input information to generate parameters associated with a funding opportunity model;
implementing the funding opportunity model;
simulating the funding opportunity with respect to the entity using the funding opportunity model; and
determining one or more aspects of the funding opportunity.

9. The method of claim 8, further comprising modifying an aspect of the funding opportunity model.

10. The method of claim 8, further comprising verifying the one or more aspects of the funding opportunity.

11. The method of claim 10, further comprising providing one or more funding options to the entity based on the one or more aspects of the funding opportunity.

12. The method of claim 8, wherein the parameters include one of a label and a feature.

13. The method of claim 8, wherein the one or more aspects of the funding opportunity include an amount of the funding opportunity, an interest rate for the funding opportunity, and a duration of the funding opportunity.

14. The method of claim 8, further comprising receiving a selection from the entity with respect to the one or more funding options.

15. A non-transitory computer-readable storage medium having an executable stored thereon, which when executed instructs a processor to:
access input information related to a funding opportunity associated with an entity;
analyze the input information to generate parameters associated with a funding opportunity model;
implement the funding opportunity model;
simulate the funding opportunity with respect to the entity using the funding opportunity model; and
determine one or more aspects of the funding opportunity.

16. The non-transitory computer-readable storage medium of claim 15, wherein the executable when executed further instructs the processor to modify an aspect of the funding opportunity model.

17. The non-transitory computer-readable storage medium of claim 15, wherein the executable when executed further instructs the processor to verify the one or more aspects of the funding opportunity.

18. The non-transitory computer-readable storage medium of claim 17, wherein the executable when executed further instructs the processor to provide one or more funding options to the entity based on the one or more aspects of the funding opportunity.

19. The non-transitory computer-readable storage medium of claim 15, wherein the parameters include one of a label and a feature.

20. The non-transitory computer-readable storage medium of claim 15, wherein the one or more aspects include an amount of the funding opportunity, an interest rate for the funding opportunity, and a duration of the funding opportunity.
